(19) United States
(12) Patent Application Publication
(10) Pub. No.: US 2019/0367713 A1
(43) Pub. Date: Dec. 5, 2019

(54) Conductive Articles Produced from a Composite Material and Process to Produce Such Articles

(71) Applicant: TOTAL RESEARCH & TECHNOLOGY FELUY, Seneffe (BE)

(72) Inventors: Dimitri Rousseaux, Nivelles (BE); Olivier Lhost, Havre (BE)

(21) Appl. No.: 16/477,578

(22) PCT Filed: Jan. 12, 2018
(86) PCT No.: PCT/EP2018/050728

§ 371 Date: Jul. 12, 2019

(30) Foreign Application Priority Data
Jan. 13, 2017 (EP) 17151446.6
Oct. 6, 2017 (EP) 17195329.2

(51) Int. Cl. C08L 23/06; C08J 3/22; H01B 1/24; F16L 9/12

(52) U.S. Cl. CPC C08L 23/06; C08J 3/226; H01B 1/24; F16L 9/125; C08L 2310/00; B29C 48/022; C08L 2205/06; C08L 2205/025; C08L 2203/18; C08L 2205/03; C08L 2203/20

(57) ABSTRACT

The invention relates to a conductive article such as a pipe or a container, wherein the article is made from a composite material comprising from 50 to 99 wt % of a first polyethylene resin having an HLMI ranging from 1 to 50 g/10 min, a melt index MI2 of at most 0.45 g/10 min, and a density ranging from 0.920 g/cm³ to 0.980 g/cm³; from 0.2 to 10 wt % of carbon particles selected from nanographene, carbon nanotubes (CNT) or any combination thereof; and from 0.01 to 5.0 wt % of one or more processing aids. The conductive article has a surface resistivity of at most 1.10⁶ ohm/sq as determined according to silver ink method. The invention also relates to a process to produce such conductive article.

### FIELD OF THE INVENTION

The present invention relates to conductive articles made from polyethylene compositions such as pipes that can be used in mining applications, geomembranes or containers. The invention also relates to a process for the preparation of such conductive articles.

### BACKGROUND OF THE INVENTION

Polymer materials, such as polyethylene (PE), are frequently used for preparing pipes suitable for various purposes, such as fluid transport, i.e. transport of liquid or gas, e.g. water or natural gas, during which the fluid can be pressurized.

PE pipes are generally manufactured by extrusion, by blow-moulding or by injection moulding. The properties of such conventional PE pipes are sufficient for many purposes, although enhanced properties may be desired, for instance in applications requiring high-pressure resistance, i.e. pipes that are subjected to an internal fluid pressure for a long and/or a short period of time.

According to ISO 9080, PE pipes are classified by their minimum required strength, i.e. their capability to withstand different hydrostatic (hoop) stress during 50 years at 20° C. without fracturing. Thereby, pipes withstanding a hoop stress of 8.0 MPa (minimum required strength MRS8.0) are classified as PE80 pipes, and pipes withstanding a hoop stress of 10.0 MPa (MRS10.0) are classified as PE100 pipes.

Moreover, the transported fluid may have varying temperatures, thus according to ISO 24033, polyethylene of raised temperature resistance (PE-RT) pipes of type II shall not give any brittle failures indicating the presence of a knee at any temperature up to 110° C. within one year.

PE80 pipes, PE100 pipes and PE-RT pipes are usually prepared from specific polyethylene grades, such as medium density polyethylene and high-density polyethylene. PE80 pipes and PE100 pipes are usually produced from a polyethylene resin showing a high viscosity and having, therefore, a melt index MI5 of at most 1.5 g/10 min as determined according to ISO 1133 at 190° C. under a load of 5 kg. PE-RT pipes are usually produced from a polyethylene resin having a melt index MI2 of at most 5.0 g/10 min as determined according to ISO 1133 at 190° C. under a load of 2.16 kg.

If conductive pipes are required, such as for mining application, the polyethylene can be then blended with carbon particles such as carbon black. It has been experienced that, in order to achieve the desired electrical properties on the surface of the pipes, the composite material comprising the polyethylene and the carbon particles should contain at least 15 wt % of carbon particles as based on the total weight of the composite material. Unfortunately, the carbon particles content directly influences the mechanical properties obtained on the pipe such as the impact failure properties. As a general rule, when a polyethylene is blended with a filler (such as carbon black) the higher the filler content is, the worse the impact properties are.

Similar problems arise with containers, such as car fuel tank (CFT), or with geomembrane when produced from polyethylene. PE-CFT are usually prepared from polyethylene, such as medium density polyethylene and high-density polyethylene, having a high viscosity and therefore a high load melt index HLMI of at most 10 g/10 min as determined according to ISO 1133 at 190° C. under a load of 21.6 kg. The addition of carbon particles to achieve targeted electrical properties results in a loss of mechanical properties such as a loss of the impact properties.

Thus, there is a need for a solution to achieve good electrical properties (such as good surface resistivity) in conductive articles, such as pipes, geomembranes or containers, such as car fuel tanks, while keeping at the same time good mechanical properties and in particular good impact properties.

### SUMMARY OF THE INVENTION

It is therefore an object of the present invention to provide conductive articles, such as pipes suitable for mining applications, geomembranes or containers (such as car fuel tanks), the articles having good mechanical properties and being conductive or at least dissipative, wherein the articles are produced from composite material comprising a polyethylene and a low content of carbon particles such as nanographenes or carbon nanotubes. It is another object of the present invention to provide conductive articles, such as pipes suitable for mining applications, geomembranes or containers (such as car fuel tanks), the articles having good mechanical properties and being conductive or at least dissipative. It is also an object of the invention to provide a process to produce said articles having good mechanical properties and being conductive or at least dissipative wherein the articles are made from a composite material having a low content of carbon particles.

According to a first aspect, the invention relates to a conductive article wherein the article is made from a composite material comprising:
from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, a melt index MI2 of at most 0.45 g/10 min as determined according to ISO 1133 at 190° C. under a load of 2.16 kg, and a density of at least 0.920 g/cm³ and of at most 0.980 g/cm³ as determined according to ISO 1183 at a temperature of 23° C.;
from 0.2 to 10 wt % of carbon particles as based on the total weight of said composite material as determined according to ISO 11358 selected from nanographene, carbon nanotubes (CNT) or any combination thereof; and
from 0.01 to 5.0 wt % of one or more processing aids as based on the total weight of said composite material, wherein the one or more processing aids is selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide, and any mixture thereof;
   and further wherein the conductive article has a surface resistivity of at most 1.10⁶ ohm/sq as determined according to the silver ink method.

Surprisingly, it has been found by the inventors that the addition of one or more processing aids within the composite material allows at similar CNT and/or nanographenes content, better electrical properties compared to articles produced without such processing aids. The addition of one or more processing aids allows reducing the content of carbon particles within the composite material. It is, therefore, possible to achieve the targeted electrical properties for example on pipes with a CNT content as low as less than 5 wt %. As the impact properties are directly influenced by the filler content, the invention provides conductive articles with an improved balance of electrical and mechanical properties. Moreover, as the content of carbon particles can be lowered, the invention results, for targeted electrical properties, in less expensive articles with better mechanical properties.

Indeed, without being bound by a theory it is believed that the high shear resulting from the contact of the extrusion or injection device with the viscous polyethylene results in the formation of carbon particles composition from the top surface of the produced article up to the center, such that an insulating layer with very few carbon particles can be found at the extreme surface of the article. The use of one or more processing aids in the composite material formulation surprisingly helps in solving this problem as it is demonstrated in the examples. This effect is surprising as processing aids such since fluoroelastomer are known to migrate to the surface of the article during extrusion and to coat the equipment surface, whereas at the same time a surface conductivity should be created by the formation of a carbon particles pattern at the surface of the article. With preference one or more of the following embodiments can be used to define the inventive conductive article:
The article is selected from pipes, geomembranes or containers. Preferably the containers are car fuel tanks.
The first polyethylene resin has a melt index MO2 of less than 0.42 g/10 min as determined according to ISO 1133 at 190° C. under a load of 2.16 kg, preferably of less than 0.40 g/10 min, more preferably of less than 0.35 g/10 min.
The first polyethylene resin has a high load melt index HLMI of at most 45 g/10 min as determined according to ISO 1133 at 190° C. under a load of 21.6 kg, preferably of at most 40 g/10 min, more preferably of at most 20 g/10 min, even more preferably of at most 18 g/10 min, and most preferably of at most 14 g/10 min.
The conductive article is a pipe and the first polyethylene resin has a high load melt index HLMI of at least 5 g/10 min as determined according to ISO 1133 at 190° C. under a load of 21.6 kg, preferably of at least 7 g/10 min.
The conductive article is a pipe and the first polyethylene resin has a high load melt index HLMI of at most 50 g/10 min as determined according to ISO 1133 at 190° C. under a load of 21.6 kg, preferably of at most 45 g/10 min, more preferably of at most 40 g/10 min.
The conductive article is a pipe and the first polyethylene resin has a melt index MI5 of at least 0.1 g/10 min as determined according to ISO 1133 at 190° C. under a load of 5 kg, preferably of at least 0.2 g/10 min.
The conductive article is a pipe and the first polyethylene resin has a melt index MI5 of at most 5.0 g/10 min as determined according to ISO 1133 at 190° C. under a load of 5 kg, preferably of at most 2.0 g/10 min, more preferably of at most 1.5 g/10 min, even more preferably of at most 1.0 g/10 min, most preferably of at most 0.9 g/10 min, and even most preferably of at most 0.7 g/10 min.
The conductive article is a container and the first polyethylene resin has a high load melt index HLMI of at least 5 g/10 min as determined according to ISO 1133 at 190° C. under a load of 21.6 kg, preferably of at least 6 g/10 min.
The conductive article is a geomembrane and the first polyethylene resin has a high load melt index HLMI of at most 20 g/10 min as determined according to ISO 1133 at 190° C. under a load of 21.6 kg, preferably of at most 18 g/10 min, and more preferably of at most 15 g/10 min.
The first polyethylene resin has a density of at least 0.920 g/cm³ and of at most 0.960 g/cm³ as determined according to ISO 1183 at a temperature of 23° C.
For pipe and container applications, the first polyethylene resin has a density of at least 0.930 g/cm³ and of at most 0.960 g/cm³ as determined according to ISO 1183 at a temperature of 23° C.
For geomembranes, the first polyethylene resin has a density of at least 0.920 g/cm³ and of at most 0.945 g/cm³ as determined according to ISO 1183 at a temperature of 23° C.
The first polyethylene resin has a molecular weight distribution Mw/Mn of at least 2 and of at most 25, Mw being the weight-average molecular weight and Mn being the number-average molecular weight, preferably the first polyethylene resin has a molecular weight distribution Mw/Mn of at least 7 and/or of at most 30.
The first polyethylene resin has a monomodal molecular weight distribution or a bimodal molecular weight distribution, preferably the first polyethylene resin has a bimodal molecular weight distribution.
The first polyethylene resin is a polyethylene copolymer, which is a copolymer of ethylene and at least one C₃-C₂₀ alpha-olefin, preferably 1-hexene.
The first polyethylene resin is a polyethylene copolymer and has a commoner content of at least 1 wt % and at most 5 wt % as based on the total weight of the polyethylene copolymer.
The first polyethylene resin is a Ziegler-Natta catalyzed polyethylene resin, a chromium catalyzed resin or a single-site catalyst catalyzed resin. Preferably, the first polyethylene resin is a Ziegler-Natta catalyzed polyethylene resin.
The composite material comprises at least 2.0 wt % of carbon particles as based on the total weight of the composite material, preferably at least 2.5 wt %, more preferably at least 3.0 wt %.
The composite material comprises at least 0.2 wt % of carbon particles as based on the total weight of said composite material as determined according to ISO11358 selected from nanographenes, carbon nanotubes (CNT) or any combination thereof, preferably at least 0.5 wt %, more preferably at least 1.0 wt %, even more preferably at least 2.0 wt %; most preferably of at least 2.6 wt % and even most preferably of at least 3.0 wt %.
The composite material comprises at most 9 wt % of carbon particles as based on the total weight of said composite material as determined according to ISO11358 selected from nanographenes, carbon nanotubes (CNT) or any combination thereof, preferably at most 8.5 wt %, and more preferably at most 8 wt %.
The carbon particles are carbon nanotubes and the composite material comprises from 0.2 to 5.0 wt % of carbon particles as based on the total weight of the composite material as determined according to IS011358, preferably the composite material comprises from 0.5 to 4.8 wt %, more preferably from 2.0 to 4.5 wt %, even more preferably from 2.6 to 4.2 wt %, and most preferably from 3.0 to 4.0 wt % of carbon particles as based on the total weight of the composite material.
The carbon particles are carbon nanotubes having an average L/D ratio of at least 1000 and the composite material comprises from 0.2 to 5.0 wt % of carbon particles as based on the total weight of the composite material as determined according to ISO 11358, preferably the composite material comprises from 0.5 to 4.8 wt %.
The carbon particles are carbon nanotubes having an average L/D ratio of at most 500 and the composite material comprises from 1.0 to 5.0 wt % of carbon particles as based on the total weight of the composite material as determined according to ISO 11358, preferably the composite material comprises from 2.6 to 4.8 wt %.
The carbon particles are nanographenes and the composite material comprises from 5.0 to 10.0 wt % of carbon particles as based on the total weight of the composite material as determined according to ISO11358, preferably the composite material comprises from 6.0 to 9.0 wt % of carbon particles as based on the total weight of the composite material.
The composite material comprises at most 1.5 wt % of one or more processing aids as based on the total weight of said composite material, preferably at most 1.0 wt %, more preferably at most 0.8 wt %, most preferably at most 0.5 wt %.
The one or more processing aids are selected from fluoroelastomers, zinc stearate, calcium stearate, magnesium stearate, polyethylene oxide, and any mixture thereof; more preferably the one or more processing aids is or comprises a fluoroelastomer.

According to a second aspect, the invention relates to a process to produce a conductive article as defined according to the first aspect of the invention, the conductive article being produced from a composite material wherein the process comprises the following steps:
a. providing from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, and a density of at least 0.920 g/cm³ and of at most 0.980 g/cm³ as determined according to ISO 1183 at a temperature of 23° C.;
b. providing from 0.2 to 10 wt % of carbon particles as based on the total weight of said composite material as determined according to ISO 11358 selected from nanographene, carbon nanotubes or any combination thereof, wherein the carbon particles are provided with a masterbatch comprising the blend of a second polyethylene resin and at least 5 wt % of carbon particles as based on the total weight of said masterbatch as determined according to ISO 11358; the masterbatch has an HLMI of at least 5 g/10 min and of at most 500 g/10 min as determined according to ISO 1133 at 190° C. under a load of 21.6 kg; and
c. providing from 0.01 to 5.0 wt % of one or more processing aids as based on the total weight of said composite material, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide and any mixture thereof;
d. blending the first polyethylene resin with the carbon particles and the one or more processing aids, and
e. forming an article by extrusion, blow moulding or injection moulding.

In an embodiment, both the carbon particles and at least a part of the one or more processing aids are provided with a masterbatch, wherein:
the masterbatch comprises from 0.01 to 4.0 wt % of one or more processing aids based on the total weight of the masterbatch, said one or more processing aids being selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof;
   and further wherein the steps b) and c) are conducted together in a single step.

With preference, in all embodiments wherein a masterbatch is used, the masterbatch is produced by blending together a second polyethylene resin having a melting temperature Tm as measured according to ISO 11357-3, carbon particles and one or more optional processing aids, in an extruder comprising a transport zone and a melting zone maintained at a temperature comprised between Tm+1° C. and Tm+50° C., preferably comprised between Tm +5° C. and Tm+30° C.

Preferably, the second polyethylene resin has a melt flow index MI2 ranging from 5 to 250 g/10 min as measured according to ISO 1133 under a load of 2.16 kg.

In an embodiment the masterbatch comprises from 0.01 to 4.0 wt % of one or more processing aids based on the total weight of the masterbatch, said one or more processing aids being selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof; wherein the one or more processing aids are added in the masterbatch pure or in the form of another masterbatch.

With preference, in all embodiments, the step d) and the step e) are performed together in a single extrusion apparatus, a single blow moulding apparatus or in a single injection moulding apparatus. Thus, the different components of the composite material are dry blended together and directly provided to the extrusion apparatus or to the injection moulding apparatus. The different components of the composite material are not melt blended and not chopped into pellets before the shaping step (by extrusion or by injection) to form a pipe, a geomembrane or a container.

According to a third aspect, the invention relates to the use of one or more processing aids in a composite material used to form a conductive article according to the first aspect, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof. More preferably the one or more processing aids is or comprises a fluoroelastomer.

According to a fourth aspect, the invention relates to the use of one or more processing aids in a process according to the second aspect of the invention for producing conductive article, wherein the one or more processing aids being selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof. More preferably, the one or more processing aids is or comprises a fluoroelastomer.

### DETAILED DESCRIPTION OF THE INVENTION

For the purpose of the invention the following definitions are given:

As used herein, a “polymer” is a polymeric compound prepared by polymerizing monomers, whether of the same or a different type. The generic term polymer thus embraces the term homopolymer, usually employed to refer to polymers prepared from only one type of monomer, and the terms copolymer and interpolymer as defined below.

As used herein, a “copolymer”, “interpolymer” and like terms mean a polymer prepared by the polymerization of at least two different types of monomers. These generic terms include polymers prepared from two or more different types of monomers, e.g. terpolymers, tetrapolymers, etc.

As used herein, “blend”, “polymer blend” and like terms refer to a composition of two or more compounds, for example, two or more polymers or one polymer with at least one other compound.

As used herein, the term “melt blending” involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

As used herein the terms “polyethylene” (PE) and “ethylene polymer” may be used synonymously. The term “polyethylene” encompasses homopolyethylenes as well as copolymers of ethylene which can be derived from ethylene and a comonomer such as one or more selected from the group consisting of C₃-C₂₀-alpha-olefins, such as 1-butene, 1-propylene, 1-pentene, 1-hexene, 1-octene.

The term “polyethylene resin” as used herein refers to polyethylene fluff or powder that is extruded, and/or melted and/or pelletized and can be produced through compounding and homogenizing of the polyethylene resin as taught herein, for instance, with mixing and/or extruder equipment. As used herein, the term “polyethylene” may be used as a shorthand for “polyethylene resin”.

The term “fluff” or “powder” as used herein refers to polyethylene material with the hard catalyst particle at the core of each grain and is defined as the polymer material after it exits the polymerization reactor (or the final polymerization reactor in the case of multiple reactors connected in series).

Under normal production conditions in a production plant, it is expected that the melt index (MI2, HLMI, MI5) will be different for the fluff than for the polyethylene resin. Under normal production conditions in a production plant, it is expected that the density will be slightly different for the fluff than for the polyethylene resin. Unless otherwise indicated, the density and the melt index for the polyethylene resin refer to the density and melt index as measured on the polyethylene resin as defined above. The density of the polyethylene resin refers to the polymer density as such, not including additives such as pigments unless otherwise stated.

The term “carbon particles” as used herein encompasses carbon nanotubes and nanographene but excludes carbon fibres.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

The Conductive Articles

The invention provides a conductive article wherein the article is made from a composite material comprising:
from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, and a density of at least 0.930 g/cm³ and of at most 0.980 g/cm³ as determined according to ISO 1183 at a temperature of 23° C.;
from 0.2 to 10 wt % of carbon particles as based on the total weight of said composite material as determined according to ISO 11358 selected from nanographene, carbon nanotubes (CNT) or any combination thereof; and
from 0.01 to 5 wt % of one or more processing aids as based on the total weight of said composite material, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide, and any mixture thereof;
   and further wherein the conductive article has a surface resistivity of at most 1.10⁶ ohm/sq as determined according to the silver ink method.

The conductive articles according to the invention show a lower content of carbon particles than similar articles known from prior art. As the filler content is lower, the articles have a better balance of electrical and mechanical properties. Moreover, the low content of carbon particles makes them less expensive.

The articles are preferably selected from pipes, geomembranes or containers (such as car fuel tanks).

The term “pipe” as used herein is meant to encompass pipes in the narrower sense, as well as supplementary parts like fittings, valves and all parts which are commonly necessary for e.g. a hot water piping system.

Pipes according to the invention also encompass single and multilayer pipes, where for example one or more of the layers is a metal layer and which may include an adhesive layer. Other constructions of pipes, e.g. corrugated pipes, are possible as well.

Should multilayered pipes or multilayered containers (such as car fuel tanks) be considered, the conductive layer made of the composite material is the inner and/or the outer layer. Should multilayered geomembranes be considered, the conductive layer made of the composite material is one or both of the surface layers.

In a preferred embodiment, the conductive article has a surface resistivity lower than 5.10⁵ ohms/sq as determined according to the silver ink method, preferably lower than 2.10⁵ ohms/sq. The conductive article may have a surface resistivity of at least 1.10² ohm/sq, preferably, of at least 5.10² ohm/sq as determined according to the silver ink method. In a preferred embodiment, the composite material has a surface resistivity lower than 1.10⁷ ohms/sq as determined according to the silver ink method, preferably lower than 1.10⁶ ohm/sq, more preferably lower than 1.10⁵ ohm/sq, most preferably lower than 1.10⁴ ohm/sq, in particular lower than 5.10³ ohm/sq. The composite material may have a surface resistivity of at least 1.10² ohm/sq, preferably, of at least 5.10² ohm/sq as determined according to the silver ink method.

The First Polyethylene

The composite material comprises a first polyethylene resin which is selected to be suitable for the application considered (pipe or containers).

Whatever the application considered, the first polyethylene resin has preferably a high load melt index HLMI of at most 50 g/10 min as determined according to ISO 1133 at 190° C. under a load of 21.6 kg, preferably of at most 45 g/10 min, and more preferably of at most 40 g/10 min.

With preference, the first polyethylene resin has a melt index MI2 of less than 0.42 g/10 min as determined according to ISO 1133 at 190° C. under a load of 2.16 kg, preferably of less than 0.40 g/10 min, more preferably of less than 0.35 g/10 min.

However, it is possible to further select more precisely the first polyethylene in accordance with the targeted application.

In a preferred embodiment, wherein the article is a pipe, the first polyethylene resin may be selected as follows:

Preferably, the first polyethylene resin has a high load melt index HLMI of at least 5 g/10 min as determined according to ISO 1133 at 190° C. under a load of 21.6 kg, preferably of at least 6 g/10 min, and more preferably of at least 7 g/10 min.

In order to achieve targeted mechanical properties, the first polyethylene resin may have a melt index MI5 of at least 0.1 g/10 min as determined according to ISO 1133 at 190° C. under a load of 5 kg, preferably of at least 0.2 g/10 min.

In an embodiment, the first polyethylene resin may have a melt index MI5 of at most 5.0 g/10 min as determined according to ISO 1133 at 190° C. under a load of 5 kg, preferably of at most 2.0 g/10 min, more preferably of at most 1.5 g/10 min, even more preferably of at most 1.0 g/10 min, most preferably of at most 0.9 g/10 min, and even most preferably of at most 0.7 g/10min.

In embodiments requiring the first polyethylene to be of the PE80 grade or the PE100 grade the first polyethylene resin has preferably a high load melt index HLMI of at most 20 g/10 min as determined according to ISO 1133 at 190° C. under a load of 21.6 kg, preferably of at most 18 g/10 min, and more preferably of at most 14 g/10 min.

The first polyethylene resin may be any PE80 grade, PE100 grade or PE-RT grade commercially available.

In another embodiment, wherein the article is a container, the first polyethylene resin may be selected to have a high load melt index HLMI of at least 5 g/10 min as determined according to ISO 1133 at 190° C. under a load of 21.6 kg, preferably of at least 6 g/10 min.

The first polyethylene resin may be any container or car fuel tank grade commercially available.

In another embodiment, wherein the article is a geomembrane the first polyethylene resin may be selected to have a high load melt index HLMI of at most 20 g/10 min as determined according to ISO 1133 at 190° C. under a load of 21.6 kg, preferably of at most 18 g/10 min, and more preferably of at most 15 g/10 min.

Whatever the article is (a geomembrane, a pipe or a container), the first polyethylene resin has preferably a density of at least 0.925 g/cm³ as determined according to ISO 1183 at a temperature of 23° C., and preferably of at least 0.935 g/cm³.

In an embodiment, the first polyethylene resin has preferably a density of at most 0.970 g/cm³ as determined according to ISO 1183 at a temperature of 23° C., preferably of at most 0.960 g/cm³ more preferably of at most 0.955 g/cm³.

For pipe and container applications, the first polyethylene resin has preferably a density of at least 0.930 g/cm³ and of at most 0.960 g/cm³ as determined according to ISO 1183 at a temperature of 23° C. For geomembranes, the first polyethylene resin has a density of at least 0.920 g/cm³ and of at most 0.945 g/cm³ as determined according to ISO 1183 at a temperature of 23° C.

The first polyethylene resin may have a molecular weight distribution Mw/Mn of at least 2 and of at most 25, Mw being the weight-average molecular weight and Mn being the number-average molecular weight, preferably the first polyethylene resin has a molecular weight distribution Mw/Mn of at least 7 and/or of at most 30.

The first polyethylene resin has a monomodal molecular weight distribution or a bimodal molecular weight distribution, preferably the first polyethylene resin has a bimodal molecular weight distribution.

As used herein, the term “monomodal polyethylene” or “polyethylene with a monomodal molecular weight distribution” refers to polyethylene having one maximum in their molecular weight distribution curve, which is also defined as a unimodal distribution curve. As used herein, the term “polyethylene with a bimodal molecular weight distribution” or “bimodal polyethylene” refers to polyethylene having a distribution curve being the sum of two unimodal molecular weight distribution curves, and refers to a polyethylene product having two distinct but possibly overlapping populations of polyethylene macromolecules each having different weight average molecular weights. As used herein, the term “polyethylene with a multimodal molecular weight distribution” or “multimodal polyethylene” refers to polyethylene with a distribution curve being the sum of at least two, preferably more than two unimodal distribution curves, and refers to a polyethylene product having two or more distinct but possibly overlapping populations of polyethylene macromolecules each having different weight average molecular weights. The multimodal polyethylene resin of the article can have an “apparent monomodal” molecular weight distribution, which is a molecular weight distribution curve with a single peak and no shoulder. In an embodiment, said polyethylene resin having a multimodal, preferably bimodal, molecular weight distribution can be obtained by physically blending at least two polyethylene fractions. In a preferred embodiment, said polyethylene resin having a multimodal, preferably bimodal, molecular weight distribution can be obtained by the chemical blending of at least two polyethylene fractions, for example by using at least 2 reactors connected in series.

The first polyethylene can be produced by polymerizing ethylene and one or more optional co-monomers, optionally hydrogen, in the presence of a catalyst being a metallocene catalyst, a Ziegler-Natta catalyst or a chromium catalyst.

In an embodiment, the first polyethylene resin is a Ziegler-Natta catalyzed polyethylene resin, preferably having a bimodal molecular weight distribution.

The term “Ziegler-Natta catalyst” or “ZN catalyst” refers to catalysts having a general formula M<1>XV, wherein M<1> is a transition metal compound selected from group IV to VII from the periodic table of elements, wherein X is a halogen, and wherein V is the valence of the metal. Preferably, M<1> is a group IV, group V or group VI metal, more preferably titanium, chromium or vanadium and most preferably titanium. Preferably, X is chlorine or bromine, and most preferably, chlorine. Illustrative examples of the transition metal compounds comprise but are not limited to TiCl3 and TiCl4. Suitable ZN catalysts for use in the invention are described in U.S. Pat. No. 6,930,071 and U.S. Pat. No. 6,864,207, which are incorporated herein by reference.

In an embodiment, the first polyethylene resin is a chromium catalyzed polyethylene resin, preferably having a monomodal molecular weight distribution.

The term “chromium catalysts” refers to catalysts obtained by deposition of chromium oxide on a support, e.g. a silica or aluminium support. Illustrative examples of chromium catalysts comprise but are not limited to CrSiO₂ or CrAl₂O₃.

In an embodiment, the first polyethylene resin is obtained in the presence of a single site catalyst, preferably a metallocene catalyst. Preferably the first polyethylene has a bimodal molecular weight distribution.

The single-site catalyst-based catalytic systems are known to the person skilled in the art. Amongst these catalysts, metallocenes are preferred. The metallocene catalysts are compounds of Group IV transition metals of the Periodic Table such as titanium, zirconium, hafnium, etc., and have a coordinated structure with a metal compound and a ligand composed of one or two groups of cyclopentadienyl, indenyl, fluorenyl or their derivatives. The use of metallocene catalysts in the polymerisation of olefins has various advantages. Metallocene catalysts have high activities and are capable of preparing polymers with enhanced physical properties. Metallocenes comprise a single metal site, which allows for more control on branching and on the molecular weight distribution of the polymer.

The metallocene component used to prepare the first polyethylene can be any bridged metallocene known in the art. Supporting method and polymerisation processes are described in many patents, for example in WO2012/001160A2 which is enclosed by reference in its entirety. Preferably, it is a metallocene represented by the following general formula:

μR¹(C₅R²R³R⁴R⁵)(C₅R⁶R⁷R⁸R⁹)MX¹X² (III)

wherein:
the bridge R¹ is —(CR¹⁰R¹¹)ₚ- or —(SiR¹⁰R¹¹)ₚ- with p=1 or 2, preferably it is —(SiR¹⁰R¹¹)—;
M is a metal selected from Ti, Zr and Hf, preferably it is Zr;
X¹ and X² are independently selected from the group consisting of halogen, hydrogen, C₁-C₁₀ alkyl, C₆-C₁₅ aryl, alkylaryl with C₁-C₁₀ alkyl and C₆-C₁₅ aryl;
R², R³, R⁴, R⁵, R⁶, R⁷, R⁸, R⁹, R¹⁰ and R¹¹ are each independently selected from the group consisting of hydrogen, C₁-C₁₀ alkyl, C₅-C₇ cycloalkyl, C₆-C₁₅ aryl, alkylaryl with C₁-C₁₀ alkyl and C₆-C₁₅ aryl, or any two neighboring R may form a cyclic saturated or non-saturated C₄-C₁₀ ring; each R², R³, R⁴, R⁵, R⁶, R⁷, R⁸, R⁹, R¹⁰ and R¹¹ may, in turn, be substituted in the same way.

The preferred metallocene components are represented by the general formula (Ill), wherein
the bridge R¹ is SiR¹⁰R¹¹;
M is Zr;
X¹ and X² are independently selected from the group consisting of halogen, hydrogen, and C₁-C₁₀ alkyl; and
(C₅R²R³R⁴R⁵) and (C₅R⁶R⁷R⁸R⁹) are indenyl of the general formula C₉R¹²R¹³R¹⁴R¹⁵R¹⁶R¹⁷R¹⁸R¹⁹, wherein R¹², R₁₃, R¹⁴, R¹⁵, R¹⁶, R¹⁷, and R¹⁸ are each independently selected from the group consisting of hydrogen, C₁-C₁₀ alkyl, C₅-C₇ cycloalkyl, C₆-C₁₅ aryl, and alkylaryl with C₁-C₁₀ alkyl and C₆-C₁₅ aryl, or any two neighboring R may form a cyclic saturated or non-saturated C₄-C₁₀ ring;
R¹⁰ and R¹¹ are each independently selected from the group consisting of C₁-C₁₀ alkyl, C₅-C₇ cycloalkyl, and C₆-C₁₅ aryl, or R¹⁰ and R¹¹ may form a cyclic saturated or non-saturated C₄-C₁₀ ring; and
each R¹⁰, R¹¹, R¹², R¹³ R¹⁴ R¹⁵ R¹⁶ R¹⁷ and R¹⁸ may, in turn, be substituted in the same way.

Particularly suitable metallocenes are those having C₂-symmetry or several characterized by a C1 symmetry.

Examples of particularly suitable metallocenes are:
dimethylsilanediyl-bis(cyclopentadienyl)zirconium dichloride,
dimethylsilanediyl-bis(2-methyl-cyclopentadienyl)zirconium dichloride,
dimethylsilanediyl-bis(3-methyl-cyclopentadienyl)zirconium dichloride,
dimethylsilanediyl-bis(3-tert-butyl-cyclopentadienyl)zirconium dichloride,
dimethylsilanediyl-bis(3-tert-butyl-5-methyl-cyclopentadienyl)zirconium dichloride,
dimethylsilanediyl-bis(2,4-dimethyl-cyclopentadienyl)zirconium dichloride,
dimethylsilanediyl-bis(indenyl)zirconium dichloride,
dimethylsilanediyl-bis(2-methyl-indenyl)zirconium dichloride,
dimethylsilanediyl-bis(3-methyl-indenyl)zirconium dichloride,
dimethylsilanediyl-bis(3-tert-butyl-indenyl)zirconium dichloride,
dimethylsilanediyl-bis(4,7-dimethyl-indenyl)zirconium dichloride,
dimethylsilanediyl-bis(tetrahydroindenyl)zirconium dichloride,
dimethylsilanediyl-bis(benzindenyl)zirconium dichloride,
dimethylsilanediyl-bis(3,3′-2-methyl-benzindenyl)zirconium dichloride,
dimethylsilanediyl-bis(4-phenyl-indenyl)zirconium dichloride,
ethylene-bis(indenyl)zirconium dichloride,
ethylene-bis(tetrahydroindenyl)zirconium dichloride,
isopropylidene-(3-tert-butyl-5-methyl-cyclopentadienyl)(fluorenyl) zirconium dichloride.

The metallocene may be supported according to any method known in the art. In the event it is supported, the support used in the present invention can be any organic or inorganic solid, particularly a porous support such as silica, talc, inorganic oxides, and resinous support material such as polyolefin. Preferably, the support material is an inorganic oxide in its finely divided form.

The first polyethylene resin may be a polyethylene copolymer, which is a copolymer of ethylene and at least one comonomer selected from C₃-C₂₀ alpha-olefin. As used herein, the term “co-monomer” refers to olefin co-monomers which are suitable for being polymerized with ethylene monomers. Co-monomers may comprise but are not limited to aliphatic C₃-C₂₀ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene. Preferably, the co-monomer is 1-hexene.

When the first polyethylene resin is a polyethylene copolymer, it preferably has a commoner content of at least 1 wt % and at most 5 wt % as based on the total weight of the polyethylene copolymer.

The Carbon Particles

In all embodiments, the carbon particles of the composite material are a carbonaceous material. In a preferred embodiment, the carbon particles of the composite material are nanoparticles. The nanoparticles used in the present invention can generally be characterized by having a size from 1 nm to and 5 μm. In the case of, for example, nanotubes, this definition of size can be limited to two dimensions only, i.e. the third dimension may be outside of these limits. Preferably, the nanoparticles are selected from the group of carbon nanoparticles. In an embodiment, the nanoparticles are selected from the group comprising carbon nanotubes, nanographene, nanographite, and blends thereof. Preferably, the nanoparticles are selected from the group comprising carbon nanotubes, carbon nanofibers, nanographenes and blends thereof. More preferred are carbon nanotubes, nanographene, and blends of these. Most preferred are carbon nanotubes.

The invention provides an article produced from a composite material having a reduced content of carbon particles compared to prior art. Thus, preferably, the composite material comprises at most 9 wt % of carbon particles as based on the total weight of said composite material as determined according to ISO 11358 selected from nanographenes, carbon nanotubes (CNT) or any combination thereof, preferably at most 8.5 wt %, and more preferably at most 8 wt %.

With preference, the composite material comprises at least 0.2 wt % of carbon particles as based on the total weight of said composite material as determined according to ISO 11358 selected from nanographenes, carbon nanotubes (CNT) or any combination thereof, preferably at least 0.5 wt %, and more preferably at least 1.0 wt %.

In a preferred embodiment, the composite material comprises at least 2.0 wt % of carbon particles as based on the total weight of the composite material, and as determined according to ISO 11358 selected from nanographenes, carbon nanotubes (CNT) or any combination thereof, preferably at least 2.5 wt %, more preferably at least 3.0 wt %.

Should the carbon particles be nanographene, the composite material may advantageously comprise from 5 to 10 wt % of carbon particles as based on the total weight of the composite material as determined according to ISO 11358, preferably the composite material comprises from 6 to 9 wt % of nanographenes as based on the total weight of the composite material.

The content of carbon particles can be further lowered by selecting carbon nanotubes instead or in addition to nanographene.

In an embodiment, the carbon particles are carbon nanotubes and the composite material comprises from 0.2 to 5.0 wt % of carbon particles as based on the total weight of the composite material as determined according to ISO 11358, preferably the composite material comprises from 0.5 to 4.8 wt %.

Suitable carbon nanotubes used in the present invention can generally be characterized by having a size from 1 nm to 5 μm, this definition of size can be limited to two dimensions only, i.e. the third dimension may be outside of these limits.

Suitable carbon nanotubes also referred to as “nanotubes” herein, can be cylindrical in shape and structurally related to fullerenes, an example of which is Buckminster fullerene (C₆₀). Suitable carbon nanotubes may be open or capped at their ends. The end cap may, for example, be a Buckminster-type fullerene hemisphere. Suitable carbon nanotubes used in the present invention can comprise more than 90%, more preferably more than 95%, even more preferably more than 99% and most preferably more than 99.9% of their total weight in carbon. However, minor amounts of other atoms may also be present.

Carbon nanotubes can exist as single-walled nanotubes (SWNT) and multi-walled nanotubes (MWNT), i.e. carbon nanotubes having one single wall and nanotubes having more than one wall, respectively. In single-walled carbon nanotubes a one atom thick sheet of atoms, for example, a one atom thick sheet of graphite (also called graphene), is rolled seamlessly to form a cylinder. Multi-walled carbon nanotubes consist of a number of such cylinders arranged concentrically. The arrangement, in multi-walled carbon nanotubes, can be described by the so-called Russian doll model, wherein a larger doll opens to reveal a smaller doll.

In an embodiment, the carbon nanotubes are single-walled nanotubes characterized by an outer diameter of at least 0.5 nm, more preferably of at least 1 nm, and most preferably of at least 2 nm. Preferably their outer diameter is at most 50 nm, more preferably at most 30 nm and most preferably at most 10 nm. Preferably, the length of single-walled nanotubes is at least 0.1 μm, more preferably at least 1 μm, even more preferably at least 10 μm. Preferably, their length is at most 50 μm, more preferably at most 25 μm.

In an embodiment, the carbon nanotubes are single-walled carbon nanotubes, preferably having an average L/D ratio (length/diameter ratio) of at least 1000.

In an embodiment, the carbon nanotubes are multi-walled carbon nanotubes, more preferably multi-walled carbon nanotubes having on average from 5 to 15 walls.

Multi-walled carbon nanotubes are preferably characterized by an outer diameter of at least 1 nm, more preferably of at least 2 nm, 4 nm, 6 nm or 8 nm, and most preferably of at least 9 nm. The preferred outer diameter is at most 100 nm, more preferably at most 80 nm, 60 nm or 40 nm, and most preferably at most 20 nm. Most preferably, the outer diameter is in the range from 10 nm to 20 nm. The preferred length of the multi-walled nanotubes is at least 50 nm, more preferably at least 75 nm, and most preferably at least 100 nm. In an embodiment, the multi-walled carbon nanotubes have an average outer diameter in the range from 10 nm to 20 nm or an average length in the range from 100 nm to 10 μm or both. In an embodiment, the average L/D ratio (length/diameter ratio) is at least 5, preferably at least 10, preferably at least 25, preferably at least 50, preferably at least 100, and more preferably higher than 100.

In an embodiment, the carbon nanotubes having an average L/D ratio of at least 1000 and the composite material comprises from 0.2 to 5.0 wt % of carbon particles as based on the total weight of the composite material as determined according to ISO 11358, preferably the composite material comprises from 0.5 to 4.8 wt %.

In another embodiment, the carbon particles are carbon nanotubes having an average L/D ratio of at most 500 and the composite material comprises from 1.0 to 5.0 wt % of carbon particles as based on the total weight of the composite material as determined according to ISO 11358, preferably the composite material comprises from 2.0 to 4.8 wt %, more preferably from 2.6 to 4.5 wt %, even more preferably from 2.8 to 4.2 wt %, and most preferably from 3.0 to 4.0 wt % of carbon particles as based on the total weight of the composite material.

Suitable carbon nanotubes to be used in the present invention can be prepared by any method known in the art. Non-limiting examples of commercially available multi-walled carbon nanotubes are Graphistrength™ 100, available from Arkema, Nanocyl™ NC 7000 available from Nanocyl, FloTube™ 9000 available from CNano Technology.

Nanocyl™ NC 7000 available from Nanocyl are carbon nanotubes having an average L/D ratio of at most 500.

The One or More Processing Aids

In an embodiment, the composite material comprises at most 1.5 wt % of one or more processing aids as based on the total weight of said composite material, preferably at most 1.0 wt %, more preferably at most 0.8 wt %, and even more preferably of at most 0.5 wt %.

The one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide, and any mixture thereof. The polyethylene oxide, in accordance with the invention, is a polyoxyethylene having a weight average molecular weight Mw of at least 20,000 g/mol, preferably of at least 25,000 g/mol.

In an embodiment, the one or more processing aids are selected from fluoroelastomers, zinc stearate, calcium stearate, and any mixture magnesium stearate; more preferably the one or more processing aids are selected from fluoroelastomers.

The one or more processing aids can be added by any known method. In an embodiment, the one or more processing aids can be provided with a masterbatch containing from 0.001 to 20 wt. %, preferably from 0.01 to 10 wt .%, more preferably from 0.01 to 4.0 wt. % of one or more processing aids based on the total weight of the masterbatch. In another embodiment, alternative or complementary to the preceding one, the one or more processing aids are added pure in the extruder in the main feeder but it is preferably added via a side-feeder.

In all embodiments of the invention, the composite material may further comprise one or more additives different from the listed processing aids, the one or more additive being selected from the group comprising an antioxidant, an antiacid, a UV-absorber, an antistatic agent, a light stabilizing agent, an acid scavenger, a lubricant, a nucleating/clarifying agent, a colorant or a peroxide. An overview of suitable additives may be found in Plastics Additives Handbook, ed. H. Zweifel, 5^{th} edition, 2001, Hanser Publishers, which is hereby incorporated by reference in its entirety.

In all embodiments of the invention, the composite material may comprise from 0% to 45% by weight of one or more filler, preferably from 1% to 35% by weight. The one or more filler being selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, natural fibres, glass fibres. With preference the filler is talc.

The invention also encompasses the article as described herein wherein the composite material comprises from 0% to 10% by weight of at least one additive such as antioxidant, based on the total weight of the composite material. In a preferred embodiment, said composite material comprises less than 5% by weight of additive, based on the total weight of the composite material, for example from 0.1 to 3% by weight of additive, based on the total weight of the composite material.

In an embodiment, the composite material comprises an antioxidant. Suitable antioxidants include, for example, phenolic antioxidants such as pentaerythritol tetrakis[3-(3′,5′-di-tert-butyl-4′-hydroxyphenyl)propionate] (herein referred to as Irganox 1010), tris(2,4-ditert-butylphenyl) phosphite (herein referred to as Irgafos 168), 3DL-alpha-tocopherol, 2,6-di-tert-butyl-4-methylphenol, dibutylhydroxyphenylpropionic acid stearyl ester, 3,5-di-tert-butyl-4-hydroxyhydrocinnamic acid, 2,2′-methylenebis(6-tert-butyl-4-methyl-phenol), hexamethylene bis[3-(3,5-di-tert-butyl-4-hydroxyphenyl)propionate], benzenepropanamide,N,N′-1,6-hexanediyl bis[3,5-bis(1,1-dimethylethyl)-4-hydroxy] (Antioxidant 1098), Diethyl 3.5-Di-Tert-Butyl-4-Hydroxybenzyl Phosphonate, Calcium bis[monoethyl(3,5-di-tert-butyl-4-hydroxylbenzyl)phosphonate], Triethylene glycol bis(3-tert-butyl-4-hydroxy-5-methylphenyl)propionate (Antioxidant 245), 6,6′-di-tert-butyl-4,4′-butylidenedi-m-cresol, 3,9-bis(2-(3-(3-tert-butyl-4-hydroxy-5-methylphenyhpropionyloxy-1,1-dimethylethyl)-2,4,8,10-tetraoxaspiro[5.5]undecane, 1,3,5-trimethyl-2,4,6-tris(3,5-di-tert-butyl-4-hydroxybenzyl)benzene, 1,1,3-tris(2-methyl-4-hydroxy-5-tert-butylphenyl)butane, (2,4,6-trioxo-1,3,5-triazine-1,3,5(2H,4H,6H)-triyl)triethylene tris[3-(3,5-di-tert-butyl-4-hydroxyphenyl)propionate], tris(3,5-di-tert-butyl-4-hydroxybenzyl) isocyanurate, Tris(4-tert-butyl-3-hydroxy-2,6-dimethylbenzyl) isocyanurate, ethylene bis[3,3-bis(3-tert-butyl-4-hydroxyphenyl)butyrate], and 2,6-bis[[3-(1,1-dimethylethyl)-2-hydroxy-5-methylphenyl]octahydro-4,7-methano-1H-indenyl]-4-methyl-phenol. Suitable antioxidants also include, for example, phenolic antioxidants with dual functionality such 4,4′-Thio-bis(6-tert-butyl-m-methyl phenol) (Antioxidant 300), 2,2′-Sulfanediylbis(6-tert-butyl-4-methylphenol) (Antioxidant 2246-S), 2-Methyl-4,6-bis(octylsulfanylmethyl)phenol, thiodiethylene bis[3-(3,5-di-tert-butyl-4-hydroxyphenyl)propionate], 2,6-di-tert-butyl-4-(4,6-bis(octylthio)-1,3,5-triazin-2-ylamino)phenol, N-(4-hydroxyphenyl)stearamide, bis(1,2,2,6,6-pentamethyl-4-piperidyl) [[3,5-bis(1,1-dimethylethyl)-4-hydroxphenyl]methyl]butylmalonate, 2,4-di-tert-butylphenyl 3,5-di-tert-butyl-4-hydroxybenzoate, hexadecyl 3,5-di-tert-butyl-4-hydroxy-benzoate, dimethylethyl)-6-[[3-(1,1-dimethylethyl)-2-hydroxy-5-methylphenyl] methyl]-4-methylphenyl acrylate, and Cas nr. 128961-68-2 (Sumilizer GS). Suitable antioxidants also include, for example, aminic antioxidants such as N-phenyl-2-naphthylamine, poly(l,2-dihydro-2,2,4-trimethyl-quinoline), N-isopropyl-N′-phenyl-p-phenylenediamine, N-Phenyl-1-naphthylamine, CAS nr. 68411-46-1 (Antioxidant 5057), and 4,4-bis(alpha,alpha-dimethylbenzyl)diphenylamine (Antioxidant KY 405). Preferably, the antioxidant is selected from pentaerythritol tetrakis[3-(3′,5′-di-tert-butyl-4′-hydroxyphenyl)propionate] (herein referred to as Irganox 1010), tris(2,4-ditert-butylphenyl) phosphite (herein referred to as Irgafos 168), or a mixture thereof.

The Process to Produce the Conductive Article

The invention also provides a process to produce the conductive article as described above. The conductive article is being produced from a composite material and the process comprises the following steps:
a. providing from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, and a density of at least 0.920 g/cm³ and of at most 0.980 g/cm³ as determined according to ISO 1183 at a temperature of 23° C.;
b. providing from 0.2 to 10 wt % of carbon particles as based on the total weight of said composite material as determined according to ISO 11358 selected from nanographene, carbon nanotubes or any combination thereof, wherein the carbon particles are provided with a masterbatch comprising the blend of a second polyethylene resin and at least 5 wt % of carbon particles as based on the total weight of said masterbatch as determined according to ISO 11358; the masterbatch has an HLMI of at least 5 g/10 min and of at most 500 g/10 min as determined according to ISO 1133 at 190° C. under a load of 21.6 kg; and
c. providing from 0.01 to 5.0 wt % of one or more processing aids as based on the total weight of said composite material, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide and any mixture thereof;
d. blending the first polyethylene resin with the carbon particles and the one or more processing aids, and
e. forming an article by extrusion, blow moulding or injection moulding.

In a preferred embodiment, in addition to the above-specified carbon nanotubes content, the masterbatch comprises from 0.001 to 10 wt %, preferably from 0.01 to 8 wt %, more preferably from 0.01 to 4.0 wt %, of one or more processing aids based on the total weight of the masterbatch, said one or more processing aids being selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof.

In such a case, both the carbon particles and at least a part, or all, of the one or more processing aids are provided with a masterbatch and the steps b) and c) are conducted in a single step, wherein:
the masterbatch comprises from 0.01 to 4.0 wt % of one or more processing aids based on the total weight of the masterbatch, said one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof.

It is to be understood that in such a case, the step d) of blending the polyethylene resin with the carbon particles and the one or more processing aids, is a step of blending the polyethylene resin with the masterbatch comprising the carbon particles and the one or more processing aids.

As used herein, the term “masterbatch” refers to concentrates of carbon particles (such as carbon nanotubes (CNT) or nanographene) and/or processing aids in a polymer, which is intended to be subsequently incorporated into another polymer miscible with the polymer already contained in the masterbatches. Use of masterbatches makes processes more easily adaptable to industrial scale, compared to direct incorporation of the carbon particles into the polyethylene composition. In accordance with the invention, two polymers are said miscible when they are of the same nature, for instance when both are polyethylene.

In all embodiments, the masterbatch preferably comprises the blend of a second polyethylene resin and from 5 to 25 wt % of carbon particles as based on the total weight of said masterbatch as determined according to ISO 11358, the carbon particles being selected from nanographene, carbon nanotubes or any combination thereof; preferably from 6 to 15 wt % of carbon particles.

With preference, in all embodiments wherein a masterbatch is used, the masterbatch is produced by blending together a second polyethylene resin having a melting temperature Tm as measured according to ISO 11357-3, carbon particles and optional one or more processing aids, in an extruder comprising a transport zone and a melting zone maintained at a temperature comprised between Tm+1° C. and Tm+50° C., preferably comprised between Tm+5° C. and Tm+30° C.

Preferably, the second polyethylene resin has a melt flow index M12 ranging from 5 to 250 g/10 min as measured according to ISO 1133 under a load of 2.16 kg.

In an embodiment, the process for the preparation of the masterbatch according to the present invention comprises the steps of:
i. providing carbon particles,
ii. providing a second polyethylene resin having a melting temperature, Tm, measured according to ISO 11357-3, and wherein said second polyethylene resin has a melt flow index preferably comprised between 5 and 250 g/10 min measured according to ISO 1133 under a load of 2.16 kg,
iii. blending together said carbon particles and said second polyethylene resin by extrusion in an extruder comprising a transport zone and a melting zone maintained at a temperature comprised between Tm+1° C. and Tm+50° C., preferably between Tm+5° C. and Tm+30° C., and
iv. forming a masterbatch through a die, said masterbatch,
   comprising at least 5 wt % of carbon particles based on the total weight of the masterbatch as determined according to ISO 11358, and
   having a high load melt index, HLMI, of from 2 g/10 min to 1000 g/10 min, preferably ranging from 10 to 1000 g/10 min, determined according to ISO 1133 under a load of 21.6 kg.

In a preferred embodiment, the process further comprises the step of blending from 0.001 to 20 wt. %, preferably from 0.01 to 10 wt. %, more preferably from 0.01 to 4.0 wt. % of one or more processing aids based on the total weight of the masterbatch, with the second polyethylene resin and the carbon particles in step iii).

Preferably, said one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof.

In a preferred embodiment, step iii) is carried out on co-rotating twin screw extruder at a screw speed of at least 300 rpm, preferably at least 500 rpm.

In a preferred embodiment, the temperature of the masterbatch at the extruder's outlet ranges from the crystallization temperature to the melting temperature of the masterbatch polymer.

In a preferred embodiment, the second polyethylene resin is a polyethylene homopolymer or a copolymer of ethylene with C₃-C₂₀ olefins; and the temperature within the transport and melting zone of the extruder, preferably over the entire length of the extruder, ranges from 140° C. to 180° C., preferably from 140° C. to 170° C., more preferably from 140° C. to 160° C., most preferably from 150° C. to 160° C. Preferably, the temperature of the masterbatch at the extruder's outlet may range from the crystallization temperature to the melting temperature of the polyethylene homopolymer or of the copolymer of ethylene with C₃-C₂₀ olefins.

A homopolymer according to this invention has less than 0.2 wt %, preferably less than 0.1 wt %, more preferably less than 0.05 wt % and most preferably less than 0.005 wt %, of alpha-olefins other than ethylene in the polymer. Most preferred, no other alpha-olefins are detectable. Accordingly, when the polyethylene of the invention is a homopolymer of ethylene, the comonomer content in the polyethylene is less than 0.2 wt %, more preferably less than 0.1 wt %, even more preferably less than 0.05 wt % and most preferably less than 0.005 wt % based on the total weight of the polyethylene.

Step d) of Forming an Article

With preference, in all embodiments, the step d) and the step e) are performed together in a single extrusion apparatus or in a single injection moulding apparatus. Thus, the different components of the composite material are dry blended together and directly provided to the extrusion apparatus or to the injection moulding apparatus. The different components of the composite material are not melt blended and not chopped into pellets before the shaping step to form a pipe, a geomembrane or a container.

This embodiment encompasses the cases wherein the carbon particles are provided with a masterbatch so that the blending of the masterbatch with the first polyethylene resin and their shaping to form a shaped composite article is done in a single step and in a single extrusion or moulding device. The inventive process allows obtaining further enhanced electrical properties on the shaped article compared with processes comprising a first step of compounding the masterbatch with the first polyethylene resin to obtain a composition and a subsequent step of shaping the composition to form a shaped article.

Preferably, in step d) of the present process, the blending is a dry blending of the masterbatch and the first polymer.

Pipes according to the invention can be produced by first plasticizing the composite material, or its components, in an extruder at temperatures in the range of from 200° C. to 250° C. and then extruding it through an annular die and cooling it.

Preferably, step e) of the present process is carried out in a twin-screw extruder with a screws rotation speed comprised between 5 to 1000 rpm, preferably between 10 and 750 rpm, more preferably between 15 and 500 rpm, most preferably between 20 and 400 rpm, in particular between 25 and 300 rpm. Twin-screw extruders are preferred to carry out step d) of the present process since high shear stress is generated which favours the enhancement of the electrical properties.

The extruders for producing the pipes can be single screw extruders or twin-screw extruders or extruder cascades of homogenizing extruders (single screw or twin screw). To produce pellets from the fluff (when homogenizing and introducing the additives), a single screw extruder can be used, preferably with an L/D of 20 to 40, or twin-screw extruders, preferably with an L/D of 20 to 40, preferably an extruder cascade is used. In some embodiments, supercritical CO₂ or water is used during extrusion to help homogenization. Variations could be considered like the use of supercritical CO₂ to help homogenization, use of water during extrusion. Optionally, a melt pump and/or a static mixer can be used additionally between the extruder and the ring die head. Ring-shaped dies with diameters ranging from approximately 16 to 2000 mm and even greater are possible.

The melted material arriving from the extruder can be first distributed over an annular cross-section via conically arranged holes and then fed to the core/die combination via a coil distributor or screen. If necessary, restrictor rings or other structural elements for ensuring uniform melt flow may additionally be installed before the die outlet.

After leaving the annular die, the pipe can be taken off over a calibrating mandrel, usually accompanied by cooling of the pipe using air cooling and/or water cooling, optionally also with inner water cooling.

Conversion into containers articles, such as car fuel tank articles, can be performed by a blow-moulding process or by injection process:

The container, such as the car fuel tank, according to the invention may be produced by the conventional blow moulding technique from a suitable parison extruded from a die. The parison could be a monolayer or a multi-layer parison. In the latter case, the conductive layer described in this patent is arranged as an external layer (inner and/or outer layers).

The injection process, if considered, is similar to what is disclosed e.g. in EP1189781.

Geomembrane process are described e.g. in US20080318015

The methods used to prepare geo-membranes are either flat sheet extrusion or blown sheet extrusion. In both methods, the heart of the process is the extruder. Pellets are fed into the extruder typically by a screw system, they are then heated, placed under pressure and formed into a hot plastic mass before reaching the die. Once the components are in the hot plastic state, they can be formed either into a flat sheet by a dovetail die or into a cylindrical sheet that is subsequently cut and folded out into a flat sheet.

In the flat sheet extrusion process, the hot plastic mass is fed into a dove tail die and exits through a horizontal straight slit. Depending upon the width of the die, one or more extruders may be needed to feed the hot plastic mass into the die. High-quality metal oilers placed in front of the slit are used to control the thickness and surface quality of the sheets. These rollers must be able to sustain pressure and temperature variations without deformation. They are connected to cooling liquids. The rollers are designed in order to control the sheet thickness to less than a 3% variation over the whole width. A third roller may be used to further cool the sheet and to improve its surface finish. The surface finish of the sheet is directly proportional to the quality of the rollers' surface. The evenly cooled finished material is then fed over support rollers to be wrapped onto a core pipe and rolled up.

In the blown extrusion process, the hot plastic mass is fed into a slowly rotating spiral die to produce a cylindrical sheet. Cool air is blown into the centre of the cylinder creating a pressure sufficient to prevent its collapsing. The cylinder of sheeting is fed up vertically: it is then closed by being flattened over a series of rollers. After the cylinder is folded together, the sheet is cut and opened up to form a flat surface and then rolled up. The annular slit through which the cylinder sheet is formed is adjusted to control the sheet's thickness. Automatic thickness control is available in modern plants. Cooling is performed by the cool air blown into the centre of the cylinder and then during the rolling up process.

Coextrusion allows the combination of different materials into a single multi-layer sheet. If multi-layer structures are considered, the conductive layer described in this patent is arranged as the external layer(s) (inner and/or outer layers).

Test Methods

The melt flow index (MI2_{PE}) of the polyethylene is determined according to ISO 1133 at 190° C. under a load of 2.16 kg.

The melt flow index (MI5_{PE}) of the polyethylene is determined according to ISO 1133 at 190° C. under a load of 5 kg.

The high load melt flow index (HLMI) of the polyethylene is determined according to ISO 1133 at 190° C. under a load of 21.6 kg.

Molecular weights are determined by Size Exclusion Chromatography (SEC) at high temperature (145° C.). A 10 mg polyethylene sample is dissolved at 160° C. in 10 mL of trichlorobenzene (technical grade) for 1 hour. Analytical conditions for the GPC-IR from Polymer Char are:
Injection volume: +/−0.4 mL;
Automatic sample preparation and injector temperature: 160° C.;
Column temperature: 145° C.;
Detector temperature: 160° C.;
Column set: 2 Shodex AT-806MS and 1 Styragel HT6E;

Flow rate: 1 mL/min;
Detector: IRS Infrared detector (2800-3000 cm⁻¹);
Calibration: Narrow standards of polystyrene (commercially available);
Calculation for polyethylene: Based on Mark-Houwink relation (log₁₀(M_{PE})=0.965909 log₁₀(M_{PS})−0.28264); cut off on the low molecular weight end at M_{pE}=1000.

The molecular weight averages used in establishing molecular weight/property relationships are the number average (Mₙ), weight average (M_{w}) and z average (M_{z}) molecular weight. These averages are defined by the following expressions and are determined from the calculated M_{I}:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD) is then calculated as Mw/Mn.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice, the intensity of a signal is obtained from its integral, i.e. the corresponding area. The data is acquired using proton decoupling, 2000 to 4000 scans per spectrum with 10 mm room temperature through or 240 scans per spectrum with a 10 mm cryoprobe, a pulse repetition delay of 11 seconds and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenise the sample, followed by the addition of hexadeuterobenzene (C₆D₆, spectroscopic grade) and a minor amount of hexamethyldisiloxane (HMDS, 99.5+ %), with HMDS serving as internal standard. To give an example, about 200 mg to 600 mg of polymer is dissolved in 2.0 mL of TCB, followed by addition of 0.5 mL of C₆D₆ and 2 to 3 drops of HMDS.

Following data acquisition, the chemical shifts are referenced to the signal of the internal standard HMDS, which is assigned a value of 2.03 ppm.

The comonomer content of a polyethylene is determined by ¹³C-NMR analysis of pellets according to the method described by G. J. Ray et al. in Macromolecules, vol. 10, n° 4, 1977, p. 773-778.

Melting temperatures Tm were determined according to ISO 11357-3 on a DSC Q2000 instrument by TA Instruments. To erase the thermal history the samples are first heated to 200° C. and kept at 200° C. for a period of 3 minutes. The reported melting temperatures Tm are then determined with heating and cooling rates of 20° C./min.

The density is determined according to ISO 1183 at a temperature of 23° C.

The content of carbon particles, such as carbon nanotubes in percentage by weight in blends (% CNT) can be determined by thermal gravimetric analysis (TGA) according to ISO 11358, using a Mettler Toledo STAR TGA/DSC 1 apparatus. Prior to the determination of the content of carbon nanotubes in % by weight in blends (% CNT), the carbon content of the carbon nanotubes in % by weight (% C-CNT) was determined as follows: 2 to 3 milligrams of carbon nanotubes were placed into a thermal gravimetric analyzer (TGA). The material was heated at a rate of 20° C./min from 30° C. to 600° C. in nitrogen (flow 100 ml/min). At 600° C., the gas was switched to air (100 ml/min), and the carbon oxidized, yielding the carbon content of the carbon nanotubes in % by weight (% C-CNT). The % C-CNT value was the average of 3 measurements. For the content of carbon nanotubes % by weight in blends (% CNT), 10 to 20 milligrams of sample was placed into a TGA. The material was heated at a rate of 20° C./min from 30° C. to 600° C. in nitrogen (100 ml/min). At 600° C., the gas was switched to air (100 ml/min), and the carbon oxidized, yielding to the carbon content of carbon nanotubes in the sample (% C-sample). The % C-sample value was the average of 3 measurements. The content of carbon nanotubes in % by weight in the sample (% CNT) was then determined by dividing the carbon content of carbon nanotubes in % by weight in samples (% C-sample) by the carbon content of the carbon nanotubes in % by weight (% C-CNT) and multiplying by 100.

% CNT=% C-sample/% C-CNT*100

The surface resistivity (SR) of the article was measured by the following silver ink method using a 2410 SourceMeter® apparatus. Conditions which were used were those described in the CEI 60167 test methods. The surface resistivity (SR) was measured on the article. The resistance measurement was performed using an electrode system made of two conductive paint lines using silver ink and an adhesive mask presenting 2 parallel slits 25 mm long, 1 mm wide and 2 mm apart. The samples were conditioned at 23° C./50% RH for minimum 4 hours before running the test. The measure of the resistance in ohm was reported to a square measurement area and expressed in ohm/square using the following equation: SR=(R×L)/d, wherein: SR is the average resistance reported to a square measurement area, conventionally called surface resistivity (expressed in ohm/sq), R is the average of the resistance measurements (ohm), L is the paint line length (cm), d is the distance between the electrodes (cm). L=2.5 cm and d=0.2 cm and SR=R×12.5. The surface resistivity (SR) value was the average of 3 measurements.

The following non-limiting examples illustrate the invention.

### Example

Example 1: Preparation of a Masterbatch Comprising Carbon Nanotubes

The carbon nanotubes used were multi-walled carbon nanotubes Nanocyl™ NC 7000, commercially available from Nanocyl. These carbon nanotubes have a surface area of 250-300 m²/g (measured by BET method), a carbon purity of about 90% by weight (measured by thermal gravimetric analysis), an average diameter of 9.5 nm and an average length of 1.5 μm (as measured by transmission electron microscopy).

The second polyethylene resin used was polyethylene PE2 with a melt flow index of 16 g/10 mn as measured according to ISO 1133 H (190° C.-2.16kg), a density of 0.935 g/cm³ (ISO 1183) and a Tm of 125° C. (ISO 11357-3).

The masterbatch M1 was prepared by blending polyethylene PE2 and carbon nanotubes, using a classical twin-screw extrusion process. Carbon nanotubes powder and polyethylene were introduced into the extruder to obtain a CNT content of about 10% by weight based on the total weight of the masterbatch. The masterbatch M1 was blended on a Leitztriz co-rotating twin screw extruder with an L/D of 52 (D=27), the barrel temperature was set at 135-140° C., to have a melt temperature of about 150° C.

The properties of the polyethylene based masterbatch are provided in below table 1:

TABLE 1
Properties of the PE masterbatch

| PE Masterbatch | M1 |
|---|---|
| PE2 (wt %) | 90 |
| PE2 MFI (g/10 min) | 16 |
| Processing aid (wt %) | — |
| CNT (w %) | 10 |
| Screw speed (RPM) | 500 |
| Throughput (kg/h) | 150 |
| Barrel temperature (° C.) | 90-100 |
| HLMI (g/10 min.) | 26.2 |
| Surface resistance⁽¹⁾, Rs | 2.7 × 10⁰ |
| (Ohm) | |
| Surface resistivity⁽¹⁾, ρs | 2.7 × 10¹ |
| (Ohm/sq) | |

⁽¹⁾as measured on compression moulded plaque from pellets according to ASTM D-257-07, the surface resistivity is measured with an accuracy of +/− 1.0 × 10¹.

Example 2: Influence of the Viscosity of the Polyethylene on Electrical Properties

Extruded blends were prepared by mixing the masterbatch M1 with different polyethylene resins commercially available from TOTAL®, having different values of melt index, under the procedure described below.

Dry-blend of 15% of masterbatch-CNT and 85% PE resin were introduced in the feed zone through the hopper and then extruded on a twin-screw extruder (screw diameter 18 mm) at a melt temperature of 230° C. (barrel temperature profile from the hopper to die: 220-230-230-230-220° C.) at 80 rpm screw speed and 2 kg/h throughput. No additives were added.

Surface resistivity was measured with resistance meter using silver ink electrodes painted on compressed moulded plates (CMP) made from CPD pellets at 230° C. during 4 min then cooled down to 30° C. at 20° C./min. The results are reported in the below table 2.

TABLE 2

| | MI2 of the | MI5 of the | | | |
|---|---|---|---|---|---|
| | resin | resin | HLMI of the | | Surface |
| | before | before | resin before | Density of | resistivity⁽¹⁾ |
| | blending | blending | blending | the resin | (Ohm/square) |
| | (190° C./ | (190° C./ | (190° C./ | before | of the |
| Resin | 2.16 kg) | 5 kg) | 21.6 kg) | blending | extruded blend |
| PE1 | 0.3 | 0.7 | 15 | 947 | >1 × 10¹⁰ |
| PE3 | 1 | Nd | 26 | 918 | 7 × 10⁴ |
| PE4 | 1.2 | Nd | 33 | 956 | 2 × 10⁴ |
| PE5 | 4 | Nd | 86 | 940 | 2 × 10³ |

⁽¹⁾as measured with the silver ink method on compressed moulded square
Nd = not determined

From the results, it can be seen the influence of the melt index of the polyethylene resin on the possibility to obtain a surface resistivity of below 5×10⁶ Ohm/square.

PE1 is commercially available from TOTAL® under the tradename XRT 70. PE1 has an MI2 of 0.3 g/10 min as measured according to ISO 1133 (190° C.—2.16 kg), an MI5 of 0.7 g/10 min as measured according to ISO 1133 (190° C.—5kg), a density of 0.949 g/cm³ (ISO 1183), a HLMI of 12 g/10 min as measured according to ISO 1133 (190° C.—21.6 kg).

PE3 is commercially available from TOTAL® under the tradename LL1810. PE4 is commercially available from TOTAL® under the tradename M5510 EP. PE5 is commercially available from TOTAL® under the tradename M4040.

Example 3: Production of a Conductive Pipe

The masterbatch M1 was dry blended with a first polyethylene resin PE1 and extruded to form a pipe.

The first polyethylene resin used was polyethylene PE1 with an MI5 of 0.7 g/10 min as measured according to ISO 1133 (190° C.—5 kg), a density of 0.949 g/cm³ (ISO 1183), a HLMI of 12 g/10 min as measured according to ISO 1133 (190° C.—21.6 kg). PE1 is commercially available from TOTAL® under the tradename XRT 70.

In all cases, the temperature at the outlet was 260° C., the screw speed was 40 rpm.

Pipe 1 is comparative, Pipe 2 is inventive. In pipe 2 the processing aid selected to produce the sample was Dynamar FX5922 commercially available from 3M. Dynamar FX5922 is an additive blend comprising from 60 to 70 wt % of polyethylene oxide (PEO) and from 25 to 35 wt % of vinylidene fluoride-hexafluoropropylene polymer.

The properties of the conductive pipes are provided in below table 3

TABLE 3
Properties of the conductive pipes

| | Pipe 1 | Pipe 2 |
|---|---|---|
| Masterbatch | M1 | M1 |
| Masterbatch (wt %) | 40 | 40 |
| PE1 (wt %) | 60 | 60 |
| PE1 MI5 (g/10 min) | 0.7 | 0.7 |
| Processing aid (wt %) | — | 0.3 |
| CNT (w %) | 4 | 4 |
| Screw speed (RPM) | 40 | 40 |
| Draw rate (m/min) | 0.5 | 0.5 |
| barrel temperature (° C.) | 260 | 260 |
| Surface resistivity⁽²⁾ of the | 1 × 10⁸ | 1 × 10⁸ |
| pipe, ρs (Ohm/sq) | | |

⁽²⁾as determined according to the method silver ink method described above the surface resistivity is done with an accuracy of +/− 1.0 × 10¹

From the results, it can be clearly seen that improved surface resistivity is achieved on the inventive pipe, at same CNT content.

1.-15. (canceled)

16. A conductive article characterized in that the article is made from a composite material comprising:
from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, a melt index MI2 of at most 0.45 g/10 min as determined according to ISO 1133 at 190° C. under a load of 2.16 kg, and a density of at least 0.920 g/cm³ and of at most 0.980 g/cm³ as determined according to ISO 1183 at a temperature of 23° C.;
from 0.2 to 10 wt % of carbon particles as based on the total weight of said composite material as determined according to ISO 11358 selected from nanographene, carbon nanotubes or any combination thereof; and
from 0.01 to 5.0 wt % of one or more processing aids as based on the total weight of said composite material, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide, and any mixture thereof;
and in that the conductive article has a surface resistivity of at most 1.10⁶ ohm/sq as determined according to the silver ink method.

17. The conductive article according to claim 16, characterized in that the composite material comprises at least 2.0 wt % of carbon particles as based on the total weight of the composite material as determined according to ISO 11358.

18. The conductive article according to claim 16, characterized in that the carbon particles are carbon nanotubes, and in that the composite material comprises from 0.2 to 5.0 wt % of carbon particles as based on the total weight of the composite material as determined according to ISO 11358.

19. The conductive article according to claim 16, characterized in that the carbon particles are nanographenes, and in that the composite material comprises from 5.0 to 10.0 wt % of carbon particles as based on the total weight of the composite material as determined according to ISO 11358.

20. The conductive article according to claim 16, characterized in that the first polyethylene resin has a melt index MI2 of less than 0.40 g/10 min as determined according to ISO 1133 at 190° C. under a load of 2.16 kg, and/or an HLMI of at most 40 g/10 min as determined according to ISO 1133 at 190° C. under a load of 21.6 kg.

21. The conductive article according to claim 16, characterized in that the article being selected from a pipe, a geomembrane or a container.

22. The conductive article according to claim 16, characterized in that the article is a pipe and in that first polyethylene resin has a melt index MI5 of at least 0.1 g/10 min and of at most 5.0 g/10 min as determined according to ISO 1133 at 190° C. under a load of 5 kg.

23. The conductive article according to claim 16, characterized in that the article is a container and the first polyethylene resin has a high load melt index HLMI of at least 5 g/10 min as determined according to ISO 1133 at 190° C. under a load of 21.6 kg.

24. The conductive article according to claim 16, characterized in that the composite material comprises at most 1.5 wt % of one or more processing aids as based on the total weight of said composite material.

25. The conductive article according to claim 16, characterized in that the one or more processing aids are or comprise a fluoroelastomer.

26. A process to produce a conductive article from a composite material, the process comprising:
a. providing from 50 to 99 wt % of a first polyethylene resin as based on the total weight of said composite material, wherein the first polyethylene resin has a high load melt index HLMI of at least 1 g/10 min and of at most 50 g/10 min as determined according to ISO 1133 at 190° C. under a load of 21.6 kg, and a density of at least 0.920 g/cm³ and of at most 0.980 g/cm³ as determined according to ISO 1183 at a temperature of 23° C.;
b. providing from 0.2 to 10 wt % of carbon particles as based on the total weight of said composite material as determined according to ISO 11358 selected from nanographene, carbon nanotubes or any combination thereof, wherein the carbon particles are provided with a masterbatch comprising the blend of a second polyethylene resin and at least 5 wt % of carbon particles as based on the total weight of said masterbatch as determined according to ISO 11358; the masterbatch has an HLMI of at least 5 g/10 min and of at most 500 g/10 min as determined according to ISO 1133 at 190° C. under a load of 21.6 kg; and
c. providing from 0.01 to 5.0 wt % of one or more processing aids as based on the total weight of said composite material, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer, cetyl trimethyl ammonium bromide, polyethylene oxide and any mixture thereof;
d. blending the first polyethylene resin with the carbon particles and the one or more processing aids to form the composite material; and
e. forming a conductive article from the composite material by extrusion, blow moulding or injection moulding, wherein the conductive article has a surface resistivity of at most 1.10⁶ ohm/sq as determined according to the silver ink method.

27. The process according to claim 26 characterized in that both the carbon particles and at least a part of the one or more processing aids are provided with a masterbatch, wherein the masterbatch comprises from 0.01 to 4.0 wt % of one or more processing aids based on the total weight of the masterbatch, said one or more processing aids being selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof; and in that the steps b) and c) are conducted together in single step.

28. The process according to claim 26 characterized in that the masterbatch is produced by blending together a second polyethylene resin having a melting temperature Tm as measured according to ISO 11357-3, carbon particles and one or more optional processing aids, in an extruder comprising a transport zone and a melting zone maintained at a temperature comprised between Tm+1° C. and Tm+50° C.

29. The process according to claim 26 characterized in that the step d) and the step e) are performed together in a single extrusion apparatus, in a single blow moulding apparatus or in a single injection moulding apparatus.

30. A use of one or more processing aids in a composite material used to produce a conductive article according to claim 16, wherein the one or more processing aids are selected from fluoroelastomers, waxes, tristearin, zinc stearate, calcium stearate, magnesium stearate, erucyl amide, oleic acid amide, ethylene-acrylic acid copolymer, ethylene vinyl acetate copolymer and cetyl trimethyl ammonium bromide, polyethylene oxide, and any mixture thereof.
